(19) United States
(12) Patent Application Publication
(10) Pub. No.: US 2002/0000917 A1
(43) Pub. Date: Jan. 3, 2002

(54) Pill dispenser with alarm

(76) Inventor: Michael Rubenstein, Dollard Des Ormeaux (CA)

Correspondence Address: MERCHANT & GOULD PC, P.O. BOX 2903, MINNEAPOLIS, MN, 55402-0903, US

(21) Appl. No.: 09/771,373

(22) Filed: Jan. 26, 2001

Related U.S. Application Data
(60) Provisional application No. 60/177,708, filed on Jan. 27, 2000.

(51) Int. Cl. G08B 23/00

(52) U.S. Cl. 340/573.1

(57) ABSTRACT

The present invention concerns a package including a predetermined number of pills, and a microprocessor. The microprocessor is preferably pre-programmed, depending on the treatment, with a time interval at which a pill must be taken. An alarm is associated with the microprocessor, so that when the predetermined time interval has elapsed, the microprocessor sends a signal to the alarm to activate it and thus alert the user that it is time to take a pill In a preferred embodiment, the microprocessor, although pre-programmed, are activated by the user only after the user takes the first pill It should be understood that, the alarm may include visual or audio signals to alert the user.

### FIELD OF THE INVENTION

The present invention relates to a pill dispenser incorporating an alarm to remind a user to take a pill.

### DESCRIPTION OF THE PRIOR ART

In the area of medical treatment by way of pills., it is known to package the pills in a variety of formats, i.e. bottles, blister packs, etc.

For some treatments, a patient will be supplied with a number of pills which must be taken at regular intervals (such as once a day, twice a day, etc.) For example, some treatments include pills to be taken once a day for 28 days. One of the problems associated with such treatments is that patients will sometimes forget to take a pill or dose, or will take the dose before or after the time at which it must be taken.

In order to partially obviate this problem, it has been proposed, for treatments that are sold in bottles, to provide a mechanical counter on the top of the bottle, so that each time the bottle is opened, the counter is incremented by 1. However, this poses a problem in that it only indicates how many pills have been taken. Furthermore, the counter may not be accurate, in that a user can open the bottle (and thus increase the count on the counter) but not take a pill.

### SUMMARY OF THE INVENTION

It is an object of the invention to provide a pill dispenser with an integrated alarm. In accordance with the invention, this object is achieved with a package including a predetermined number of pills, and programmable means. The programmable means are preferably pre-programmed, depending on the treatment, with a time interval at which a pill must be taken. Alarm means are associated with the programmable means, so that when the predetermined time interval has elapsed, the programmable means send a signal to the alarm means to activate them and thus alert the user that it is time to take a pill.

In a preferred embodiment. the programmable means, although pre-programmed, are activated by the user only after the user takes the first pill.

It should be understood that the alarm means may include visual or audio signals to alert the user.

### BRIEF DESCRIPTION OF THE DRAWINGS

The present invention and its advantages will be more easily understood after reading the following non-restrictive description of preferred embodiments thereof, made with reference to the following drawings:

FIG. 1 is a schematic representation of a package including a number of pills for a treatment and a microprocessor, including alarm means, according to a first preferred embodiment of the invention;

FIG. 2 is a schematic representation of the package of FIG. 1, further including connection means for interconnected each of the blisters in a blister pack according to a second preferred embodiment of the invention; and

FIG. 3 is a schematic representation of a blister pack including a number of pills for a treatment and an integrated microprocessor including alarm means according to a third preferred embodiment of the invention.

### DESCRIPTION OF A PREFERRED EMBODIMENT OF THE INVENTION

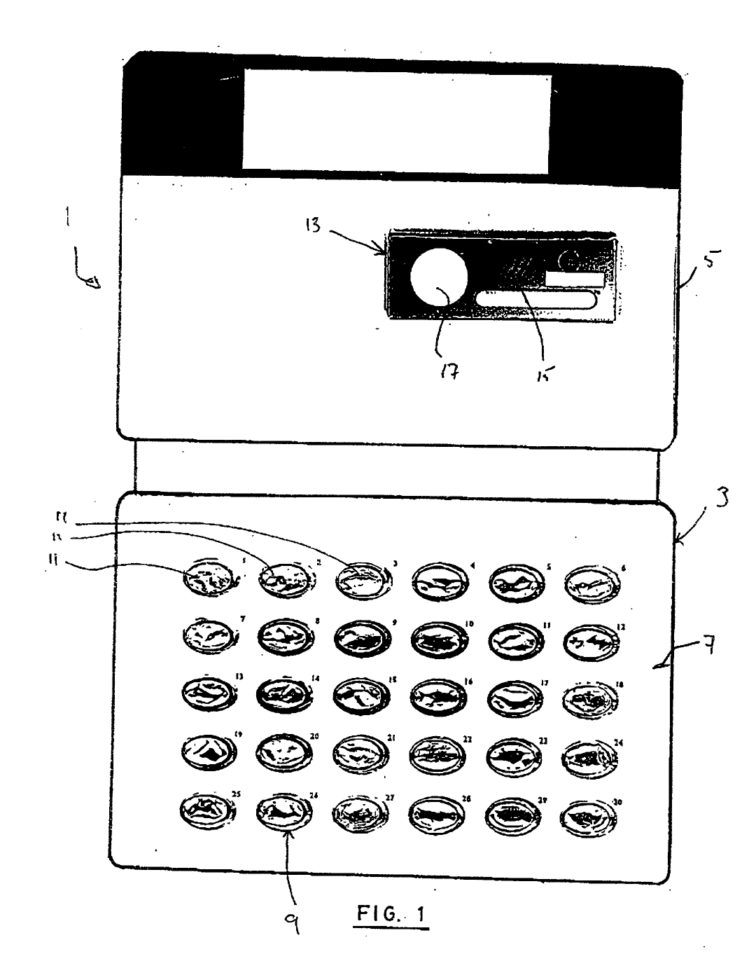

Referring now to FIG. 1, there is shown what is commonly referred to as a compliance package 1. The compliance package has a foldable support 3 (usually made of cardboard), having two sections 5, 7. The first section 5 folds over the second section 7. It should be understood that the present invention is not directed to compliance packaging in general, since such types of packaging for pills is well known in the art, nor to any other type of packaging per se. Rather, the invention is directed to the combination of a package for administering a treatment with alarm means, as will be hereinafter explained.

The second section includes what is commonly referred to as a blister pack 9. The blister pack 9 is conventionally a sheet of clear, somewhat flexible plastic, having a plurality of receptacles 11 formed therein. Each receptacle receives a pill, and the sheet of plastic is covered with a thin layer of aluminium. A user will extract a pill by pressing on the receptacle in order to break the aluminium seal. Such blister packs 9 are well known in the art and need not be further detailed.

According to a first preferred embodiment of the invention, the first section 5 includes a microprocessor means 13, encased in a housing. The microprocessor means includes a clock, and can include memory means for storing patient information and the like. If such is the case, the microprocessor means can also include a display for displaying the patient information, or other information stored in the memory.

Associated with the microprocessor means 13 is an alarm means 15. The microprocessor means 13 is pre-programmed with a predetermined time interval at which each pill of the treatment must be taken. The programming of the microprocessor means can be done at the manufacturer's, by the pharmacist or by the patient. In use, when the patient receives the treatment (or purchases it at the pharmacy), the patient activates the microprocessor means, such as, in the preferred embodiment by pushing a button 17. The pushing of the button 17 indicates to the processor means to start the clock. When the clock reaches the predetermined time interval, the microprocessor means sends a signal to the alarm means to activate the alarm means. The alarm means, which can include a visual or audible signal, or both, is thus activated, indicating to the user that it is time to take the next pill in the treatment. Accordingly, the invention provides for a more reliable way of packaging a treatment, so that the treatment is more accurately followed.

In order to reset the microprocessor means to the next time interval, the patient again presses the button 17 once the pill has been taken, and the microprocessor means starts counting anew until the predetermined time interval has elapsed.

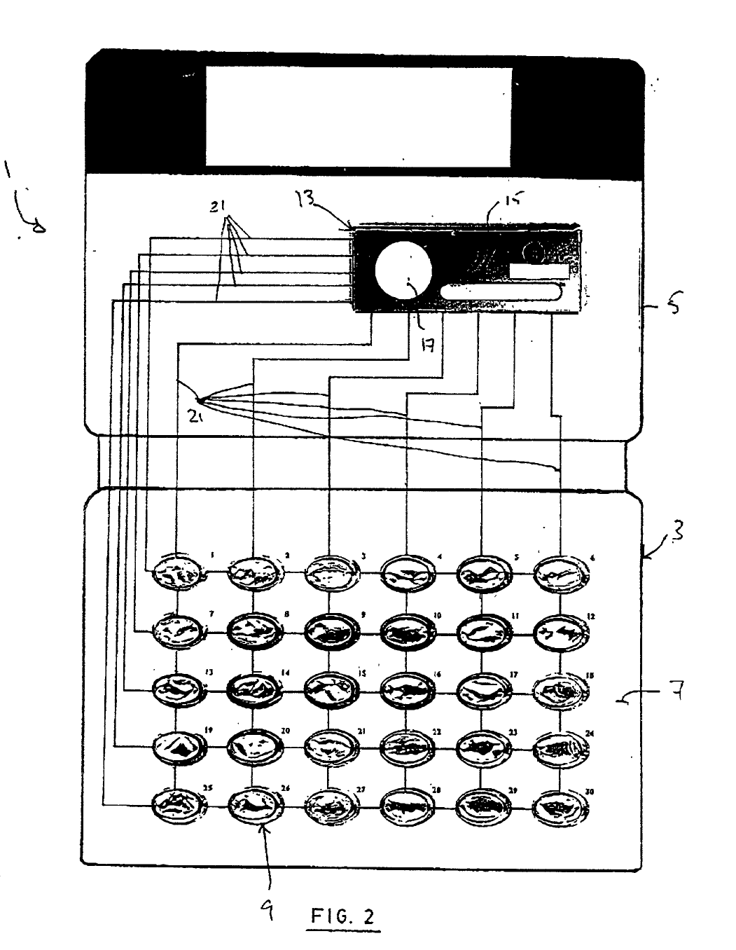

FIG. 2 shows a variation on the invention, where each of the receptacles is in one way or another operatively associated with the microprocessor means i.e. preferably interconnected by way of a matrix of wires 21 interconnecting each receptacle. This can be useful for ensuring that the treatment is taken in proper order. For example, a patient has taken the first pill in the treatment. The microprocessor registers this fact, and “knows” that the next pill in the treatment should be the second one. Should the patient break the seal on the third receptacle instead of the second one, the alarm means would send a different signal to the patient indicating to the patient has taken the wrong pill.

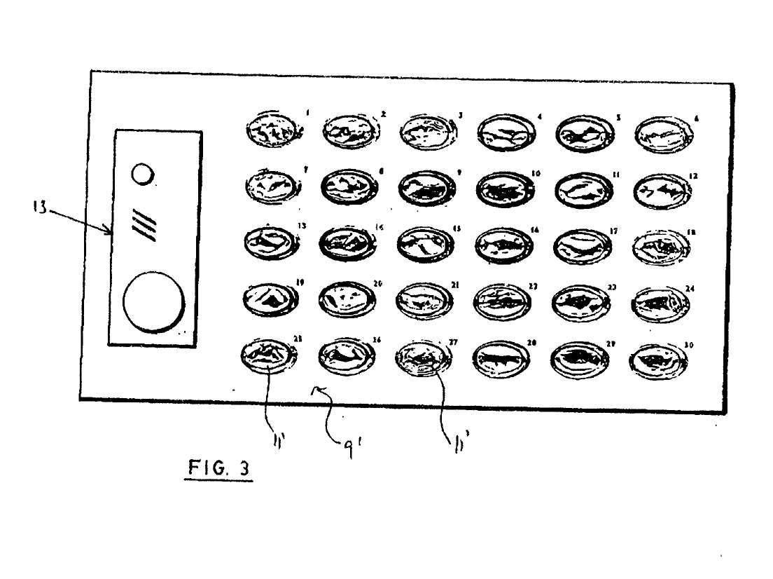

FIG. 3 shows yet another variation on the invention, where the microprocessor means, and the alarm means, are integrated on a blister pack 9′ in and of itself (without the cardboard support). Again, although not shown, each receptacle 11′ of the blister pack can be associated with the microprocessor means 13 in order to ensure that the treatment is followed in the correct order.

It should be understood that the present invention relates to the combination of a treatment with means for indicating to a patient at what time a pill must be taken. Accordingly, the present invention should not be considered as being limited to the embodiments illustrated herein, but are equally applicable, with the proper modifications, to bottles containing pills, or any other type of container. It should of course be evident that if the microprocessor means and the alarm means are integrated in the top of a bottle, there will be no way to indicate which pill should be taken next. The purpose of the interconnection of the receptacles in a blister pack is more suited to a treatment where a dose will vary in time, such as, for example, hormonal treatment, In such a case, the dose of hormones, and even the type thereof, can be varied within a treatment (i.e. one type for a week a combination of two types for the second week and another type for the third week).

Although the present invention has been explained hereinabove by way of a preferred embodiment thereof, it should be pointed out that any modifications to this preferred embodiment within the scope of the present description is not deemed to alter or change the nature and scope of the present invention.

1. A pill dispenser with an alarm, comprising:
a package holding a plurality of pills to be taken at a predetermined time interval; and
a programmable means for receiving said predetermined time interval and for activating an alarm operatively associated with the programmable means at the predetermined time intervals.

2. A pill dispenser according to claim 1, wherein said package is a compliance package.

3. A pill dispenser according to claim 1, wherein said package includes a first section and a second section the first section being foldable over the second section, and where the programmable means are located on the first section and where the plurality of pills are in the second section.

4. A pill dispenser according to claim 1, wherein the programmable means include a microprocessor including a clock.

5. A pill dispenser according to claim 1, wherein the alarm is visual.

6. A pill dispenser according to claim 1, wherein the alarm is audible.

7. A pill dispenser according to claim 4, wherein the programmable means further include manual means for starting said clock, and for resetting said clock once a pill has been taken.

8. A pill dispenser according to claim 1, wherein the package is a blister pack.

9. A pill dispenser according to claim 7, wherein the programmable means are operatively associated with each receptacle of the blister pack, and wherein said programmable means are programmed with an order in which the pills must be taken, so that if a pill is taken out of order, the programmable means activate another alarm indicating to the patient that the wrong pill has been taken.

10. A pill dispenser according to claim 1, wherein said package is a bottle, and wherein said programmable means are integrated in a cover of said bottle.

11. A pill dispenser according to claim 4, wherein said microprocessor means further include memory means.
